(19) United States
(12) Patent Application Publication
(10) Pub. No.: US 2023/0183525 A1
(43) Pub. Date: Jun. 15, 2023

(54) FILM, LIQUID PAINT, METHOD FOR PROVIDING A FILM, METHOD FOR PROVIDING A LIQUID PAINT, OPTICAL MOUNT, AND OPTICAL DEVICES

(71) Applicant: Sony Group Corporation, Tokyo (JP)

(72) Inventors: Samuel KINGSTON, Stuttgart (DE); Tonino GRECO, Stuttgart (DE)

(73) Assignee: Sony Group Corporation, Tokyo (JP)

(21) Appl. No.: 18/076,406

(22) Filed: Dec. 7, 2022

(30) Foreign Application Priority Data
Dec. 14, 2021 (EP) 21214427.3

(51) Int. Cl. C09J 7/25; C09J 7/30

(52) U.S. Cl. CPC C09J 7/25; C09J 7/30; C09J 2301/41; C09J 2479/02; C09J 2401/006

(57) ABSTRACT

A film for absorbing visible light, including:
a substrate, wherein a surface of the substrate is covered with an adhesive coating of polydopamine or a polymerized dopamine derivative.

### CROSS-REFERENCE TO RELATED APPLICATION

This application claims priority to European Application No. 21214427.3, filed Dec. 14, 2021, the entire contents of which are incorporated herein by reference.

### TECHNICAL FIELD

The present disclosure generally pertains to a film for absorbing visible light, a method for providing a film for absorbing visible light, a liquid paint for application on a surface of an object for providing a film for absorbing visible light, a method for providing a liquid paint, an optical mount, and optical devices.

### TECHNICAL BACKGROUND

Generally, nanoparticles, nanotubes, etc. are known which may have size, shape and structure dependent properties such as optical absorption and emission, reactivity and toughness. Such materials have a potential use in a variety of applications such as catalysis, photocatalysis, imaging applications, optical display devices and biomedicine.

Moreover, polydopamine (PDA) or polymerized dopamine derivatives are known, which are black in color and have broadband light absorbing properties.

Additionally, light-absorbing surface coatings are known. For example, a carbon nanotube light-absorbing surface coating is known which may absorb visible light and may provide a black surface coating.

Although there exist techniques for light-absorbing surface coatings, it is generally desirable to improve the existing techniques.

### SUMMARY

According to a first aspect the disclosure provides a film for absorbing visible light, comprising:
a substrate, wherein a surface of the substrate is covered with an adhesive coating of polydopamine or a polymerized dopamine derivative.

According to a second aspect the disclosure provides a liquid paint for application on a surface of an object for providing a film for absorbing visible light, comprising:
a substrate, wherein a surface of the substrate is covered with an adhesive coating of polydopamine or a polymerized dopamine derivative.

According to a third aspect the disclosure provides a method for providing a liquid paint for application on a surface of an object for providing a film for absorbing visible light, comprising:
mixing, in an aqueous solution, a substrate, an oxidative catalyst and dopamine or a dopamine derivative.

According to a fourth aspect the disclosure provides a method for providing a film for absorbing visible light, comprising:
mixing, in an aqueous solution, a substrate, an oxidative catalyst and dopamine or a dopamine derivative; and
applying the aqueous solution to a surface of an object.

According to a fifth aspect the present disclosure provides an optical mount configured to hold an optical element, wherein a surface of the optical mount is covered with a film for absorbing visible light, wherein the film includes a substrate, wherein a surface of the substrate is covered with an adhesive coating of polydopamine or a polymerized dopamine derivative.

According to a sixth aspect the disclosure provides an optical device, comprising:
at least one optical element; and
an optical mount configured to hold the optical element, wherein a surface of the optical mount is covered with a film for absorbing visible light, wherein the film includes a substrate, wherein a surface of the substrate is covered with an adhesive coating of polydopamine or a polymerized dopamine derivative.

According to a seventh aspect the disclosure provides an optical device, comprising:
at least one optical element; and
a housing in which the at least one optical element is arranged, wherein a surface of the housing is covered with a film for absorbing visible light, wherein the film includes a substrate, wherein a surface of the substrate is covered with an adhesive coating of polydopamine or a polymerized dopamine derivative.

Further aspects are set forth in the dependent claims, the following description and the drawings.

### BRIEF DESCRIPTION OF THE DRAWINGS

Embodiments are explained by way of example with respect to the accompanying drawings, in which:

FIG. 1 schematically illustrates an embodiment of a reaction pathway for obtaining polydopamine;

FIG. 2 schematically illustrates an embodiment of a reaction pathway for obtaining polymerized dopamine derivatives;

FIG. 3 schematically illustrates an embodiment of a film for absorbing visible light;

FIG. 4 schematically illustrates an embodiment of light attenuation principle in a film for absorbing visible light;

FIG. 5 schematically illustrates an embodiment of a light source unit in FIG. 5A and an embodiment of an optical lens unit in FIG. 5B;

FIG. 6 schematically illustrates an embodiment of a liquid paint;

FIG. 7 schematically illustrates in a flow diagram an embodiment of a method for providing a liquid paint; and

FIG. 8 schematically illustrates in a flow diagram an embodiment of a method for providing a film for absorbing visible light.

### DETAILED DESCRIPTION OF EMBODIMENTS

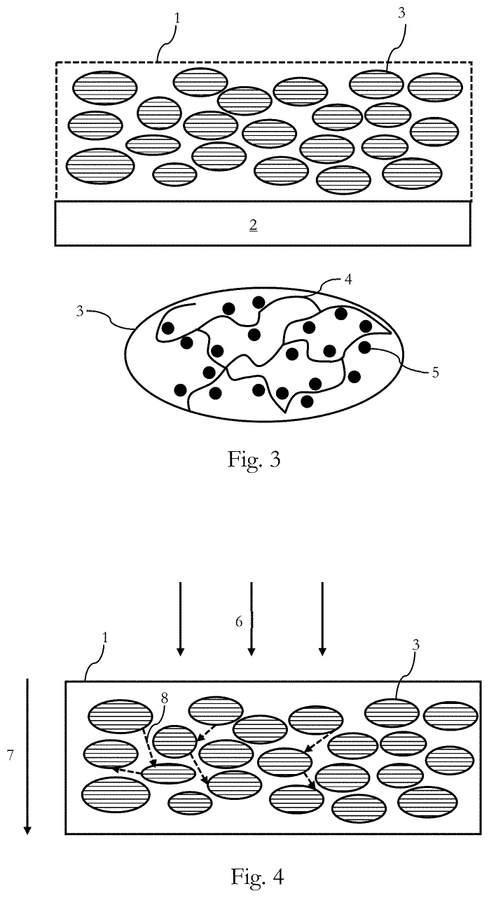

Before a detailed description of the embodiments under reference of FIG. 3 is given, general explanations are made.

As generally known, stray light sources within image sensor modules of cameras and telescopes may affect an overall performance and an accuracy of the instrument. In image modules, for example, it may limit a dynamic range and a signal-to-noise ratio (“SNR”) as it sets how dark an environment can be. Moreover, it may limit detection capabilities of telescopes and cameras, e.g. in astronomy, by effectively rendering objects in the viewing path invisible.

Typically, stray light sources may result from incident light in the viewing path or from light reflected at internal components in the telescope or the image module. For example, lens-flare may be a problematic image artefact caused by stray light, as generally known. It may limit a quality of images and videos with obscured objects.

Hence, it has been recognized that a light-absorbing material or light-absorbing surface coating may be useful in such imaging or optical instruments, since it may remove randomly generated stray light within a lens housing of the instrument. This may increase the overall performance of the instrument and may help reducing undesired effects of the stray light.

As mentioned in the outset, generally, light-absorbing surface coatings are known. For example, a carbon nanotube (“CNT”) light-absorbing surface coating is known which may absorb visible light and may provide a black surface coating.

However, as generally known, CNTs may typically be sensitive to mechanical forces, for example, they may be touch and shock sensitive.

As further mentioned in the outset, generally, polydopamine (PDA) or polymerized dopamine derivatives are known, which are black in color and have broadband light absorbing properties. Polydopamine or polymerized dopamine derivatives can be formed in a variety of ways including, for example, oxidative polymerization, as generally known.

It has been recognized that polydopamine or polymerized dopamine derivatives may be used to provide an adhesive coating by intermolecular interactions such as Van-der-Waals forces or hydrogen bonds on certain substrates.

It has further been recognized that the polydopamine or polymerized dopamine derivatives which stick to the substrate as an adhesive coating may be used as a black surface coating, e.g., for reducing stray light issues in optical devices.

Thus, it has been recognized that polydopamine or polymerized dopamine derivatives may provide a synthetic alternative to, for instance, Melanin type compounds.

A coating made of polydopamine or polymerized dopamine derivatives may consist of the active light-absorbing nanolayer which may be deposited on a variety of substrates including for example: nanocellulose, nanolignin, silica nanoparticles, nanostructured glass, nanostructured metal, metal foams, photopolymer waveguides etc.

Moreover, due to the large increase in interest in sustainability in recent years, sustainable materials would make a suitable choice for the deposition substrate as well.

A layer of polydopamine deposited on a nanostructured substrate can act as a broadband light absorbing film due to light scattering properties of the substrate and the light absorption properties of the polydopamine or polymerized dopamine derivatives. This synergy may allow the material to perform as a highly absorbing layer with reflectance less than 0.5% in some embodiments. The main benefits offered by such a coating may be mechanical stability, costs savings and sustainability.

Hence, some embodiments pertain to a film for absorbing visible light, wherein the film includes a substrate, and wherein a surface of the substrate is covered with an adhesive coating of polydopamine or a polymerized dopamine derivative.

The film may be used as a black surface coating (on a surface of an object) in light source units (e.g. LED Bayer arrays in display devices and the like), image sensors, optical lens units (e.g. inside of a housing of camera objectives, telescopes, etc.), photolithography masks, holographic displays, camouflage applications, photovoltaic cells, etc.

Some embodiments pertain to an optical mount configured to hold an optical element, wherein a surface of the optical mount is covered with a film for absorbing visible light, wherein the film includes a substrate, wherein a surface of the substrate is covered with an adhesive coating of polydopamine or a polymerized dopamine derivative.

The optical element may be a lens, a mirror, a camera objective, an optical grating, an optical crystal, an image sensor, a photovoltaic cell, a light source such as an LED (array), a photolithography mask, etc.

In some embodiments, the surface that is covered with the film is a surface which is directed towards or in contact with the optical element when the optical mount holds the optical element.

Some embodiments pertain to an optical device, including:
at least one optical element; and
an optical mount configured to hold the optical element, wherein a surface of the optical mount is covered with a film for absorbing visible light, wherein the film includes a substrate, wherein a surface of the substrate is covered with an adhesive coating of polydopamine or a polymerized dopamine derivative.

Some embodiments pertain to an optical device, including:
at least one optical element; and
a housing in which the at least one optical element is arranged, wherein a surface of the housing is covered with a film for absorbing visible light, wherein the film includes a substrate, wherein a surface of the substrate is covered with an adhesive coating of polydopamine or a polymerized dopamine derivative.

The optical device may be a camera objective, a camera, a telescope, a light source, an optical display, a beamer, a virtual reality instrument, a photolithography apparatus, an image sensor etc.

Generally, methods for producing polydopamine or polymerized dopamine derivatives are commonly known, for example, oxidative polymerization, electrochemical polymerization, self-oxidation polymerization, and enzymatic polymerization.

Methods of producing PDA involve polymerization of dopamine precursor monomers. Oxidative polymerization may take place in the presence of an oxidizing catalyst such as a stable free radical or others. Examples of stable free radicals may include TEMPO ((2,2,6,6-Tetramethylpiperidin-1-yl)oxyl or (2,2,6,6-tetramethylpiperidin-1-yl)oxidanyl), 4-amino-TEMPO, 4-carboxy-TEMPO, 4-Phosphonooxy-TEMPO, Galvinoxyl, α,γ-Bisdiphenylen-β-phenylallyl (BDPA), 3-Maleimido-PROXYL, 3-(2-Iodacetamido)-PROXYL and other radical reaction initiators. Other oxidation catalysts may be used including hydrogen peroxide (H₂O₂), hypochlorite, chlorate, chlorite, organic peroxides etc.

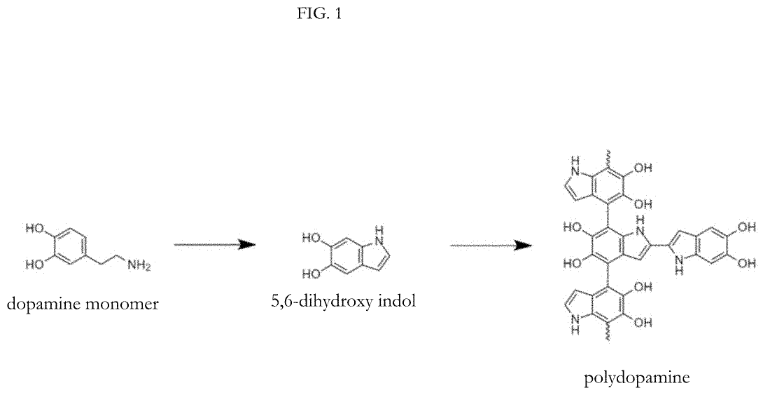

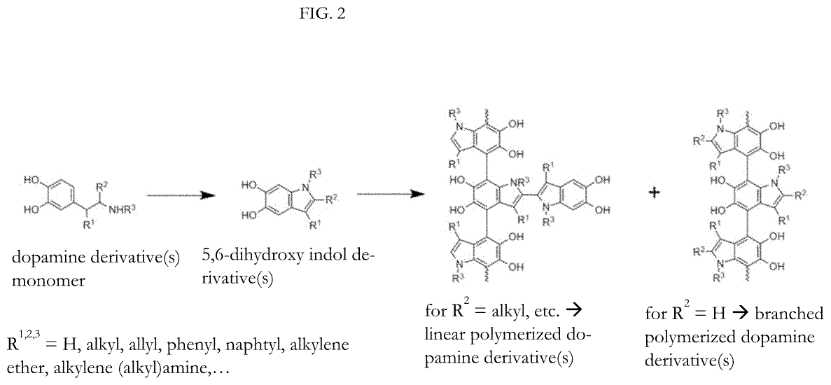

For enhancing the general understanding of the present disclosure, an embodiment of a reaction pathway for obtaining polydopamine is schematically illustrated in FIG. 1 and an embodiment of a reaction pathway for obtaining polymerized dopamine derivatives is schematically illustrated in FIG. 2, which are discussed in the following.

In FIG. 1 it is schematically illustrated that dopamine monomers react in the presence of an oxidizing catalyst to 5,6-dihydroxy indol and then polymerize to polydopamine.

In FIG. 2 it is schematically illustrated that dopamine derivative monomers react in the presence of an oxidizing catalyst to 5,6-dihydroxy indol derivatives and then form polymerized dopamine derivatives such as branched polymerized dopamine derivatives or linear polymerized dopamine derivatives.

The dopamine derivatives have substituents R^{1,2,3} selected from, for example, hydrogen, alkyl, allyl, phenyl, naphtyl, alkylene ether, alkylene (alkyl)amine.

The reaction pathways above illustrate the various structural forms that polymerized dopamine derivatives may have depending on the type of substituents attached to the dopamine starting material. The various forms of polymerized dopamine derivatives are expected to have similar light absorption properties to polydopamine derived from an unsubstituted dopamine starting material.

Returning to the general explanations, as discussed, a surface of the substrate is covered with an adhesive coating of polydopamine or a polymerized dopamine derivative.

The coating is adhesive as it is based on intermolecular interactions such as Van-der-Waals forces or hydrogen bonds without forming chemical bonds such as covalent, ionic bonds or coordination bonds with the substrate.

The film is provided, in some embodiments, by applying a liquid paint to a surface of an object and drying the liquid paint such that the film is formed on the surface of the object.

Hence, some embodiments pertain to a liquid paint for application on a surface of an object for providing a film for absorbing visible light, wherein the liquid paint includes a substrate, wherein a surface of the substrate is covered with an adhesive coating of polydopamine or a polymerized dopamine derivative.

In some embodiments, the substrate is dispersed or dissolved in an aqueous solution.

Hence, some embodiments pertain to a method for providing a liquid paint for application on a surface of an object for providing a film for absorbing visible light, wherein the method includes mixing, in an aqueous solution, a substrate, an oxidative catalyst and dopamine or a dopamine derivative.

Consequently, some embodiments pertain to a method for providing a film for absorbing visible light, wherein the method includes mixing, in an aqueous solution, a substrate, an oxidative catalyst and dopamine or a dopamine derivative and applying the aqueous solution to a surface of an object.

For example, in some embodiments, an aqueous solution of the substrate is prepared and the dopamine or dopamine derivative and the oxidative catalyst are added to the aqueous solution such that the polymerization of the dopamine or the dopamine derivative is initiated. In such embodiments, when the polydopamine or the polymerized dopamine derivative is formed, the polydopamine or the polymerized dopamine derivative covers a surface of the substrate with an adhesive coating due to the affinity of polydopamine or the polymerized dopamine derivative to the substrate caused by intermolecular interactions such as hydrogen bond formation.

In some embodiments, the polydopamine or the polymerized dopamine derivative is doped with (2,2,6,6-Tetramethylpiperidin-1-yl)oxyl. In such embodiments, the oxidative catalyst is (2,2,6,6-Tetramethylpiperidin-1-yl)oxyl (which is commonly known as TEMPO).

Typically, TEMPO-doped polydopamine or the polymerized dopamine derivative solutions display a decreased energy bandgap (HOMO-LUMO) and increased electron delocalization. This typically results in a broader absorption in the visible spectrum. However, the exact structure of TEMPO-doped polydopamine or the polymerized dopamine derivative is uncertain, although several chemical moieties are likely. These are outlined, for example, in: Yuan Zou, Xiaofeng Chen, Peng Yang, Guijie Liang, Ye Yang, Zhipeng Gu, and Yiwen Li, “Regulating the absorption spectrum of polydopamine”, SCIENCE ADVANCES, 4 Sep. 2020, Vol 6, Issue 36, DOI:10.1126/sciadv.abb4696.

In some embodiments, the substrate is or includes nanocellulose.

Generally, nanocellulose is known which can be obtained from Cellulose by chemical or physical treatment to form, for example, cellulose nanocrystals or cellulose nanofibers. Further treatment such as filtration and centrifugation, for example, may result in nanocellulose dispersed or dissolved in an aqueous solution.

The high surface area, high porosity of a nanocellulose substrate makes it a candidate, in some embodiments, for functionalisation with a polydopamine or polymerized dopamine derivatives adhesive coating. When a film including the nanocellulose covered with an adhesive coating of polydopamine or polymerized dopamine derivatives is formed on a surface of an object, any light which is not absorbed by the chemical layer (the polydopamine or polymerized dopamine derivative) itself will be repeatedly scattered within the structure of the nanocellulose until completely attenuated. Thereby, an ultra-black coating may be provided on a variety of objects.

Hence, in some embodiments, in the method for providing a liquid paint and the method for providing a film for absorbing visible light, the substrate is or includes nanocellulose and the oxidative catalyst is (2,2,6,6-Tetramethylpiperidin-1-yl)oxyl (TEMPO). In such embodiments, the polydopamine or the polymerized dopamine derivative is doped with TEMPO.

Typically, in some embodiments, TEMPO-doped polydopamine or the polymerized dopamine derivative synthesis is carried out in a water solvent, which may make it suitable for reaction in the presence of nanocellulose or nanolignin, for example.

In some embodiments, the substrate includes a plurality of silica nanoparticles.

The plurality of silica (SiO₂) nanoparticles is basically transparent and can be produced with a diameter in the range of, for example, 5 nm (“nanometer”) and (to) 1 μm (“micrometer”) without the limiting the disclosure in this regard. The plurality of silica nanoparticles may be of ellipsoid shape which may confer mechanical stability by design.

The plurality of silica nanoparticles may be produced by known methods such as colloidal synthesis. Other known methods are, for example, a sol-gel process, a reverse microemulsion or flame synthesis.

In colloidal synthesis, the plurality of silica nanoparticles may be produced in solution with an ethanol-water mixture as a solvent. Other solvents may be one of a non-polar solvent such as an alkane, an alkene, toluene, chloroform or the like, or a polar solvent such as an alcohol, an acetamide, a formamide, an ester, water, or the like, volatile solvent such as ethanol, hexane, chloroform or the like, or a combination (mixture) thereof.

In some embodiments, the plurality of silica nanoparticles has an average size in a wavelength range of the visible light.

When an average size of the plurality of silica nanoparticles is comparable to wavelengths of visible light that is incident onto the film (for example, “green light” is typically considered to have wavelengths in the range of about 500-550 nm), a light scattering effect of the plurality of silica nanoparticles in the film may increase and, thus, may provide a trapping effect in the film which keeps the visible light in the film until it is absorbed by the pigment molecules.

In some embodiments, the substrate is or includes nanolignin, nanostructured glass, nanostructured metal or metal foam.

Generally, the substrate may include nanocellulose and a plurality of silica nanoparticles in combination, for example, by mixing a solution of nanocellulose and a solution of the plurality of silica nanoparticles and adding the dopamine or dopamine derivative and an oxidative catalyst such that both a surface of the nanocellulose and the plurality of silica nanoparticles is covered with an adhesive coating of polydopamine or polymerized dopamine derivatives.

Of course, the skilled person recognizes that, in some embodiments, other combinations are possible, wherein the substrate includes any combination of the above-discussed materials as appropriate.

Generally, a nanomaterial coating (film for absorbing visible light) with several formats is discussed herein, which may be used to abate the presence of stray light in image sensor modules as well as a variety of other issues concerning light reflection. The coating may be applied to a variety of forms including flat surfaces, rounded surfaces and complex 3D shapes.

In some embodiments, at least one of the following may be provided/achieved by the film for absorbing visible light and the liquid paint for application on a surface of an object for providing a film for absorbing visible light and the corresponding method for providing the film and the liquid paint:

Improved durability of the coating, application at ambient temperature, application at ambient pressure, fast application procedure, fast deposition, simple and well demonstrated chemical process(es), cost efficient raw materials and equipment, wide range of surfaces suitable for coating, environmentally sustainable (water-based chemistry and sustainable substrate), enhanced light absorption compared to known coatings due to chemical formulation.

Returning to FIG. 3, there is schematically illustrated an embodiment of a film 1 for absorbing visible light, which is discussed in the following.

The film 1 for absorbing visible light is on a surface of an object 2, wherein the object is, for example, a separating element in a light source unit or a housing of an optical lens unit.

The film 1 includes porous nanometer substrate droplets 3, wherein the porous nanometer substrate droplets 3 include a substrate 4.

The substrate 4 is nanocellulose, wherein a surface of the nanocellulose is covered with an adhesive coating of polydopamine 5 that is doped with (2,2,6,6-Tetramethylpiperidin-1-yl)oxyl (TEMPO).

In this embodiment, the nanocellulose includes cellulose nanofibers which form an interconnected network resulting in porous nanometer substrate droplets.

The TEMPO-doped polydopamine 5 sticks to the surface of the nanofibers of the nanocellulose by strong hydrogen bonds without forming chemical bonds (ionic, covalent or coordination bonds).

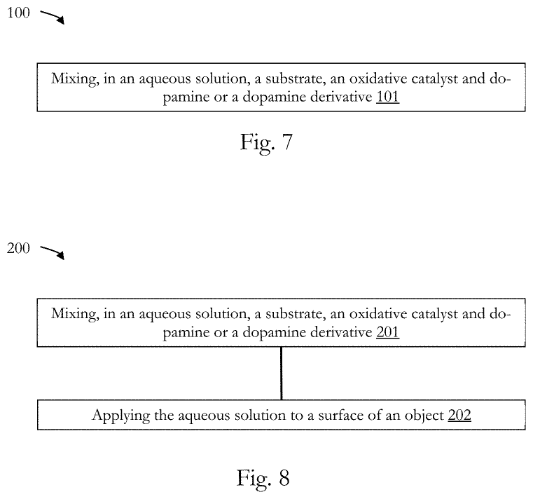

The film 1 is provided by the following method, which is discussed under reference of FIG. 7 and FIG. 8, which schematically illustrate in a flow diagram a method 100 for providing a liquid paint in FIG. 7 and a method 200 for providing a film for absorbing visible light in FIG. 8:

At 201, a liquid paint is prepared according to the method 100 of FIG. 7. Hence, at 201, as at 101, the liquid paint is provided by mixing, in an aqueous solution, the substrate 4 which is the nanocellulose, an oxidative catalyst which is the TEMPO, and dopamine monomers.

For example, at first, an aqueous solution of the nanocellulose is prepared such that the nanocellulose is dispersed or dissolved in the aqueous solution.

Then, the TEMPO and the dopamine monomers are added to the aqueous solution.

When the polydopamine is formed due to the oxidative polymerization catalyzed by TEMPO, the polydopamine covers a surface of the substrate 4 (the nanocellulose) with an adhesive coating due to the affinity of polydopamine to the nanocellulose caused by hydrogen bond formation.

Once the reaction is finished, the liquid paint is obtained and can be applied to the surface of the object 2.

Then, at 202, the liquid paint is applied to the surface of the object 2 and dried to form the film 1 on the surface of the object 2.

FIG. 4 schematically illustrates an embodiment of light attenuation principle in a film 1 for absorbing visible light, which is discussed in the following.

The film 1 for absorbing visible light corresponds to the film 1 of FIG. 3.

In the following, a light absorbing process in the film 1 will be discussed in more detail, which is based on two effects: an absorption process and a trapping effect.

Here, visible light 6 is incident onto the film 1, wherein the visible light 6 includes a plurality of wavelengths in a range which can be recognized by an average human (e.g., characterized by the luminosity function).

When the visible light 6 transmits through the film 1 in a depth direction 7, an amount of the visible light 6 (e.g., represented by a number of photons) decreases due to absorption of the visible light 6 by the TEMPO-doped polydopamine 5 which covers a surface of the nanocellulose.

Moreover, the nanocellulose scatters the visible light 6 (illustrated by the dashed arrows 8).

Accordingly, due to the scattering, the visible light 6 is trapped in the film 1 and, thus, a probability that the scattered light 8 is also absorbed, increases.

Thus, the film 1 provides a black coating for various applications.

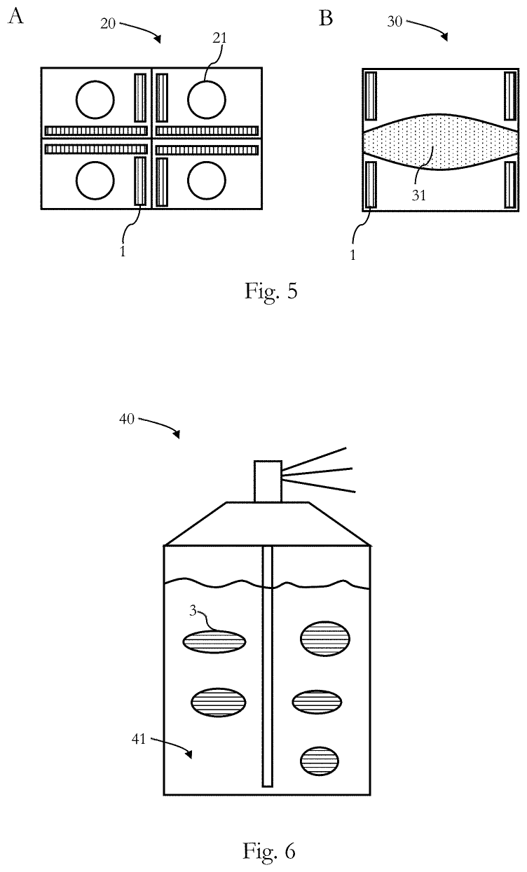

FIG. 5 schematically illustrates an embodiment of a light source unit in FIG. 5A and an embodiment of an optical lens unit in FIG. 5B, which are discussed in the following.

In FIG. 5A, a first application example of the film 1 (for details see FIG. 3 and FIG. 4) is shown.

The light source unit 20 includes four light sources 21. The light source unit 20 is an example of an optical device and the individual light sources 21 are examples of an optical element.

The light sources 21 are here light emitting diodes (“LEDs”) arranged in a Bayer array (the light source unit 20). The light source unit 20 may be part of a display device such as an LED display.

The film 1 is applied on a surface of a separating element between individual light sources 21 for improving color clarity observed by a viewer, since optical crosstalk may be reduced due to the black coating provided by the film 1.

The separating element between the individual light sources 21 corresponds in this embodiment to a surface of an optical mount in the optical device which holds the individual light sources 21.

In FIG. 5B, a second application example of the film 1 (for details see FIG. 3 and FIG. 4) is shown.

The optical lens unit 30 includes an optical lens portion 31 which may be configured to provide an objective in an optical camera. The optical lens unit 30 is an example of an optical device and the optical lens portion 31 is an example of an optical element.

As discussed herein, a typical issue in photographic applications is stray light which may be due to internal reflections at the housing of the optical lens unit 30.

The film 1 is coated on an internal surface of the housing of the optical lens unit 30 and absorbs occurring stray light and, thus, may reduce stray light issues in optical cameras.

The housing of the optical lens unit 30 corresponds in this embodiment to a surface of an optical mount in the optical device which holds the optical lens portion 31 and to a surface of a housing in the optical device in which the optical element is arranged.

FIG. 6 schematically illustrates an embodiment of a liquid paint 41, which is discussed in the following.

As mentioned herein, the film 1 may also be provided by spray coating onto a three-dimensional surface of an object.

A spray can 40 includes the liquid paint 41.

The liquid paint 41 is an aqueous solution in which the porous nanometer substrate droplets 3 (see FIG. 3) are dispersed or dissolved. The porous nanometer substrate droplets 3 include a substrate 4, wherein the substrate 4 is nanocellulose, wherein a surface of the nanocellulose is covered with an adhesive coating of polydopamine 5 that is doped with (2,2,6,6-Tetramethylpiperidin-1-yl)oxyl (TEMPO).

With the spray can 40, the liquid paint 41 can be applied directly onto surfaces for providing a black surface coating.

Thus, complex three-dimensional objects, surfaces and shapes can be provided with a black coating in a fast and cost-effective manner (e.g., black anodizing of mechanical parts is not required anymore).

Note that the present technology can also be configured as described below.

(1) A film for absorbing visible light, including:
a substrate, wherein a surface of the substrate is covered with an adhesive coating of polydopamine or a polymerized dopamine derivative.

(2) The film of (1), wherein the polydopamine or the polymerized dopamine derivative is doped with (2,2,6,6-Tetramethylpiperidin-1-yl)oxyl.

(3) The film of (1) or (2), wherein the substrate includes nanocellulose.

(4) The film of anyone of (1) to (3), wherein the substrate includes a plurality of silica nanoparticles.

(5) The film of (4), wherein the plurality of silica nanoparticles has an average size in a wavelength range of the visible light.

(6) The film of anyone of (1) to (5), wherein the substrate includes nanolignin, nanostructured glass, nanostructured metal or metal foam.

(7) A liquid paint for application on a surface of an object for providing a film for absorbing visible light, including:
a substrate, wherein a surface of the substrate is covered with an adhesive coating of polydopamine or a polymerized dopamine derivative.

(8) The liquid paint of (7), wherein the substrate is dissolved in an aqueous solution.

(9) The liquid paint of (7) or (8), wherein the polydopamine or the polymerized dopamine derivative is doped with (2,2,6,6-Tetramethylpiperidin-1-yl)oxyl.

(10) The liquid paint of anyone of (7) to (9), wherein the substrate includes nanocellulose.

(11) The liquid paint of anyone of (7) to (10), wherein the substrate includes a plurality of silica nanoparticles.

(12) The liquid paint of (11), wherein the plurality of silica nanoparticles has an average size in a wavelength range of the visible light.

(13) The liquid paint of anyone of (7) to (12), wherein the substrate includes nanolignin, nanostructured glass, nanostructured metal or metal foam.

(14) A method for providing a liquid paint for application on a surface of an object for providing a film for absorbing visible light, including:
mixing, in an aqueous solution, a substrate, an oxidative catalyst and dopamine or a dopamine derivative.

(15) The method of (14), wherein the substrate includes nanocellulose and the oxidative catalyst is (2,2,6,6-Tetramethylpiperidin-1-yl)oxyl.

(16) A method for providing a film for absorbing visible light, including:

mixing, in an aqueous solution, a substrate, an oxidative catalyst and dopamine or a dopamine derivative; and applying the aqueous solution to a surface of an object.

(17) The method of (16), wherein the substrate includes nanocellulose and the oxidative catalyst is (2,2,6,6-Tetramethylpiperidin-1-yl)oxyl.

(18) An optical mount configured to hold an optical element, wherein a surface of the optical mount is covered with a film for absorbing visible light, wherein the film includes a substrate, wherein a surface of the substrate is covered with an adhesive coating of polydopamine or a polymerized dopamine derivative.

(19) An optical device, including:
at least one optical element; and
an optical mount configured to hold the optical element, wherein a surface of the optical mount is covered with a film for absorbing visible light, wherein the film includes a substrate, wherein a surface of the substrate is covered with an adhesive coating of polydopamine or a polymerized dopamine derivative.

(20) An optical device, including:
at least one optical element; and
a housing in which the at least one optical element is arranged, wherein a surface of the housing is covered with a film for absorbing visible light, wherein the film includes a substrate, wherein a surface of the substrate is covered with an adhesive coating of polydopamine or a polymerized dopamine derivative.

1. A film for absorbing visible light, comprising:
a substrate, wherein a surface of the substrate is covered with an adhesive coating of polydopamine or a polymerized dopamine derivative.

2. The film according to claim 1, wherein the polydopamine or the polymerized dopamine derivative is doped with (2,2,6,6-Tetramethylpiperidin-1-yl)oxyl.

3. The film according to claim 1, wherein the substrate includes nanocellulose.

4. The film according to claim 1, wherein the substrate includes a plurality of silica nanoparticles.

5. The film according to claim 4, wherein the plurality of silica nanoparticles has an average size in a wavelength range of the visible light.

6. The film according to claim 1, wherein the substrate includes nanolignin, nanostructured glass, nanostructured metal or metal foam.

7. A liquid paint for application on a surface of an object for providing a film for absorbing visible light, comprising:
a substrate, wherein a surface of the substrate is covered with an adhesive coating of polydopamine or a polymerized dopamine derivative.

8. The liquid paint according to claim 7, wherein the substrate is dissolved in an aqueous solution.

9. The liquid paint according to claim 7, wherein the polydopamine or the polymerized dopamine derivative is doped with (2,2,6,6-Tetramethylpiperidin-1-yl)oxyl.

10. The liquid paint according to claim 7, wherein the substrate includes nanocellulose.

11. The liquid paint according to claim 7, wherein the substrate includes a plurality of silica nanoparticles.

12. The liquid paint according to claim 11, wherein the plurality of silica nanoparticles has an average size in a wavelength range of the visible light.

13. The liquid paint according to claim 7, wherein the substrate includes nanolignin, nanostructured glass, nanostructured metal or metal foam.

14. A method for providing a liquid paint for application on a surface of an object for providing a film for absorbing visible light, comprising:
mixing, in an aqueous solution, a substrate, an oxidative catalyst and dopamine or a dopamine derivative.

15. The method according to claim 14, wherein the substrate includes nanocellulose and the oxidative catalyst is (2,2,6,6-Tetramethylpiperidin-1-yl)oxyl.
